(19) United States
(12) Patent Application Publication
(10) Pub. No.: US 2018/0341913 A1
(43) Pub. Date: Nov. 29, 2018

(54) REDUCING THE ENVIRONMENTAL EFFECTS OF SHIPMENTS OF GOODS

(71) Applicant: Giddy Inc., New York, NY (US)

(72) Inventors: Jonathan Ching, Skillman, NJ (US); Ji Ho Koo, New York, NY (US)

(73) Assignee: Giddy Inc., New York, NY (US)

(21) Appl. No.: 15/606,825

(22) Filed: May 26, 2017

(51) Int. Cl. G06Q 10/08; G06Q 30/06

(52) U.S. Cl. CPC G06Q 10/0835; G06Q 10/0832; G06Q 99/00; G06Q 10/083; G06Q 30/0601; G06Q 30/0635

(57) ABSTRACT

Some embodiments of the invention are directed to techniques for minimizing the environmental impact of a physical shipment of items, by enabling a consumer to specify how items in the shipment are selected and/or packed. The consumer may direct that items are packed in a manner which minimizes packaging material waste, and/or which satisfies any of numerous other objectives for the shipment.

### BACKGROUND

A number of Internet retailers offer delivery of items soon after a consumer places an order, some as soon as minutes afterward. The allure of instant (or nearly instant) gratification has helped the e-commerce industry to grow at a rapid pace in recent years. However, policy makers continue to grapple with the long-term environmental costs of an economy in which consumers have come to expect that items can be delivered as quickly as they wish. These environmental costs include not only the considerable amount of container board that is used to ship items each year (an amount which is in the tens of millions of tons each year in the United States alone), but also the fossil fuels which are consumed and the emissions which are produced by delivery services.

While some may argue that an increase in online shopping means that consumers use cars less to travel to brick-and-mortar stores, and that delivery services have considerable incentive to find the most efficient routes to consumers' doorsteps (thus keeping fuel consumption and emissions down), some studies indicate that the typical consumer now orders items online in addition to still driving to brick-and-mortar stores to purchase items at least as much as in the past. For example, some studies point to the typical shopper's desire to be able to see and feel certain types of items in a brick-and-mortar store, and to return items purchased online to a brick-and-mortar store.

Consumer demand for quick delivery creates challenges for delivery companies seeking to be efficient. For example, instead of being able to plan in advance deliveries of big truckloads of items to a single brick-and-mortar retailer, a trucking company may have to make multiple scattershot deliveries to individual consumers, thereby increasing fuel consumption and emissions.

Many Internet retailers acknowledge the need to be environmentally conscious. For example, while the use of cardboard boxes for e-commerce has grown significantly in recent years, a significant portion of those boxes are now made from recycled material. However, while the use of recycled material may make consumers think that they are helping the environment, recycling has its own environmental costs, including the emissions produced in shipping used cardboard to recycling centers, and the considerable amounts of energy and water used in the recycling process.

### SUMMARY

The Assignee has appreciated that many consumers would like to have greater control over the manner in which items are shipped. For example, some consumers may wish to mitigate (to the extent possible) the environmental effects of shipping items. Accordingly, some embodiments of the invention provide a consumer with the ability to control, at least in part, the environmental effects of a shipment of items. For example, in some embodiments, a consumer may specify the extent to which any volume in a shipping container which might otherwise go unoccupied is used, so that the amount of packaging material that is wasted in the shipment may be minimized.

Further, by reducing the amount of packaging that is wasted in each of a collection of shipments that a given shipping company is to handle, some embodiments of the invention may enable the shipping company to minimize the amount of unused volume in its delivery vehicles' cargo areas, thereby enabling the shipping company to utilize its cargo space more efficiently overall, and leading to reduced fuel consumption and harmful emissions.

Some embodiments of the invention are directed to a process for producing a physical shipment of items with minimal environmental impact. For example, in some embodiments, when a consumer selects items for purchase, the physical dimensions of each selected item may be analyzed. A “bin-packing” algorithm may then be performed to select one or more shipping containers for the shipment and to arrange the selected items into a “virtual shipment” within the shipping container(s). A virtual shipment may, for example, specify a manner of packing the items within the shipping container(s) so that they occupy minimal volume, so as to minimize packaging material waste. As a result, a shipment that might otherwise require multiple shipping containers and/or excess dunnage may instead be completed with a single container and/or with less dunnage, or a shipment that might otherwise require a larger shipping container may be completed with a smaller one.

Arranging items so as to occupy minimal volume within a given shipping container also maximizes the remaining volume in the container which additional items may occupy. As such, some embodiments of the invention are directed to identifying one or more “add-on” items which will fit into the remaining volume in a shipping container and not cause the shipment to exceed any applicable weight limits, so that the smallest possible amount of packaging material may be utilized as fully as possible in the shipment. The consumer may, for example, be offered an incentive to include one or more of the identified add-on items in the shipment, such as by offering a discount on certain items. In response to the consumer selecting a particular add-on item for inclusion in the shipment, the remaining volume in the shipping container (i.e., after the selected add-on item is placed within) may be determined, so that any other add-on items that will fit into the remaining free volume, and not cause any weight limits to be exceeded, may be identified. The consumer may be offered an incentive to include one or more of these add-on items in the shipment as well. This process may continue until the consumer indicates that no more add-on items are to be included, or there are no more add-on items that will fit in the shipping container and/or not cause any weight limits for the shipment to be exceeded. As such, the consumer is given control over how the packaging material constituting the shipping container is utilized, and given the ability to minimize packaging material waste, which may also lead to reduced fuel consumption and harmful emissions.

In some embodiments, a virtual shipment which is created according to the process described above may be processed to produce a physical shipment for delivery to the consumer. For example, a virtual shipment may specify information such as the items which are selected by the consumer for inclusion in the shipment, and how the items are to be arranged within one or more shipping containers. This information may be processed (e.g., using manual, automated, or some combination of manual and automated techniques) to produce a physical shipment for delivery to the consumer.

The foregoing is a non-limiting summary of only certain aspects of the invention, some embodiments of which are described in the sections that follow.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 is a flow chart depicting a representative process for enabling a consumer to specify how items in a shipment are to be packed, in accordance with some embodiments of the invention;

FIG. 2 is a flow chart depicting a visual representation of a representative bin-packing algorithm that may be used to define how items are to be packed within one or more shipping containers, in accordance with some embodiments of the invention;

FIG. 3 is a flow chart depicting a representative process for enabling a consumer to specify one or more objectives for a shipment of items, in accordance with some embodiments of the invention;

FIG. 4 is a flow chart depicting a representative process for using virtual shipment information to produce a physical shipment for delivery to a consumer, in accordance with some embodiments of the invention; and

FIG. 5 is a block diagram depicting a representative computing system which may be used to implement certain aspects of the invention.

### DETAILED DESCRIPTION

Some embodiments of the invention are directed to techniques for minimizing the environmental impact of a physical shipment of items. For example, some embodiments are directed to packing items selected by a consumer into a shipping container in a manner which minimizes packaging material waste. Some embodiments are directed to enabling a consumer to specify how fully the packaging material constituting a given shipping container is utilized in the shipment.

In some embodiments of the invention, when a consumer selects items for purchase (e.g., by placing the items into a digital “shopping cart” provided by an e-commerce company), the physical dimensions of each selected item may be analyzed. A bin-packing algorithm may then be performed to select one or more shipping containers for the shipment and to arrange the selected items into a “virtual shipment” within the selected shipping container(s). A virtual shipment may, for example, specify a manner of packing the items so as to minimize the number of shipping containers used for the shipment and the volume occupied by the items within the shipping container(s), thereby minimizing packaging material waste. As such, a shipment that might otherwise require multiple shipping containers may be accomplished with a single container, and/or a shipment that might otherwise require a larger shipping container may be accomplished with a smaller one, thereby reducing the amount of packaging material that might otherwise be wasted in the shipment.

By determining a manner of packing items so that they occupy minimal volume, some embodiments of the invention also maximize the remaining volume which may be occupied by additional items. As such, some embodiments are directed to identifying one or more “add-on” items which will fit into the remaining volume and not cause the shipment to exceed any applicable weight limits, and to offering the consumer an incentive to include one or more of the add-on items in the shipment (e.g., by offering a discount or other incentive(s) with respect to certain add-on items). In response to the consumer selecting a particular add-on item, the remaining volume in the shipment (i.e., after the selected add-on item is virtually “placed” within a selected shipping container) may be determined, so that any more add-on items that will fit into the remaining volume and not cause any weight limits to be exceeded may be identified. The consumer may be offered an incentive to include one or more of these items in the shipment as well. This process may continue until the consumer indicates that no more add-on items are to be included, or there are no more add-on items which will fit and/or not cause any weight limits to be exceeded. As a result of this process, the packaging material constituting the shipping container(s) may be even more fully utilized in the shipment.

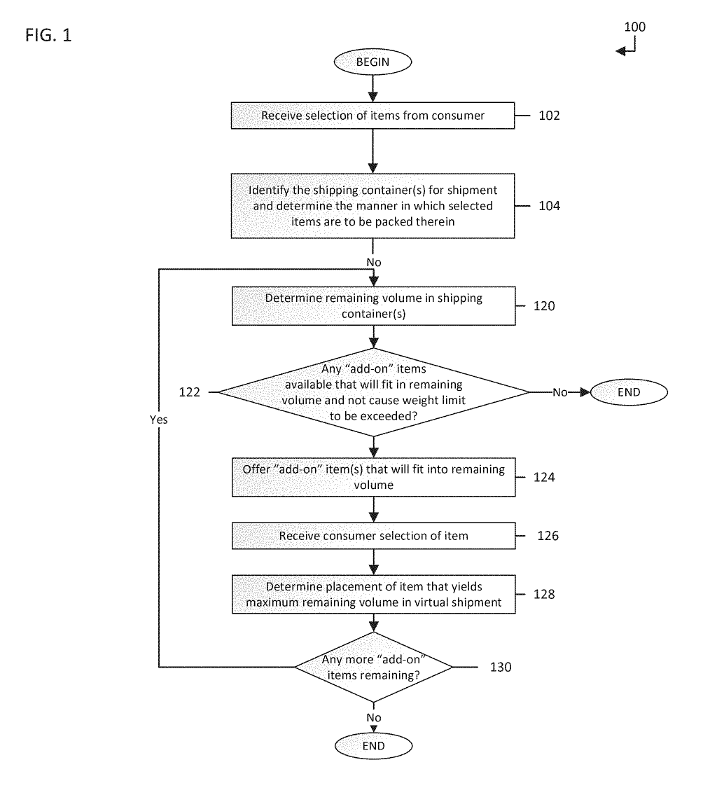

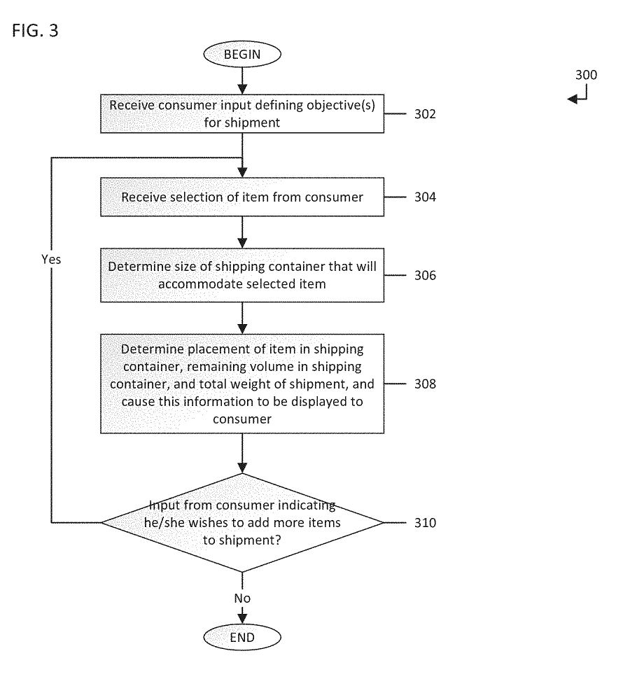

FIG. 1 depicts a representative process for minimizing the environmental impact of a shipment of items, by determining how the items should be packed in one or more shipping containers, and enabling a consumer to define the extent to which the volume provided by the shipping container(s) is occupied. The representative process shown in FIG. 1 is performed after the consumer selects an initial set of items for purchase. However, it should be appreciated that the invention is not limited to being implemented in this manner. For example, some embodiments may allow the consumer to see how each individual selected item affects a shipment, by visualizing how each such item is arranged in a shipping container, and specifying to what extent the volume in the container is utilized. One such embodiment is described in further detail below with reference to FIG. 3.

The representative process 100 shown in FIG. 1 begins in act 102, wherein a consumer's selection of items for purchase is received. For example, input may be received from the consumer indicating that he/she wishes to “check out” after having placed the selected items into a virtual “shopping cart” provided by an e-commerce company on its web site, mobile application, electronic portal, and/or any other suitable electronic facility. This input may take any suitable form. In representative process 100, each item selected by the consumer has physical dimensions which are known a priori. Of course, the invention is not limited to such an implementation. For example, the physical dimensions of an item may be determined in response to a consumer selecting it for purchase.

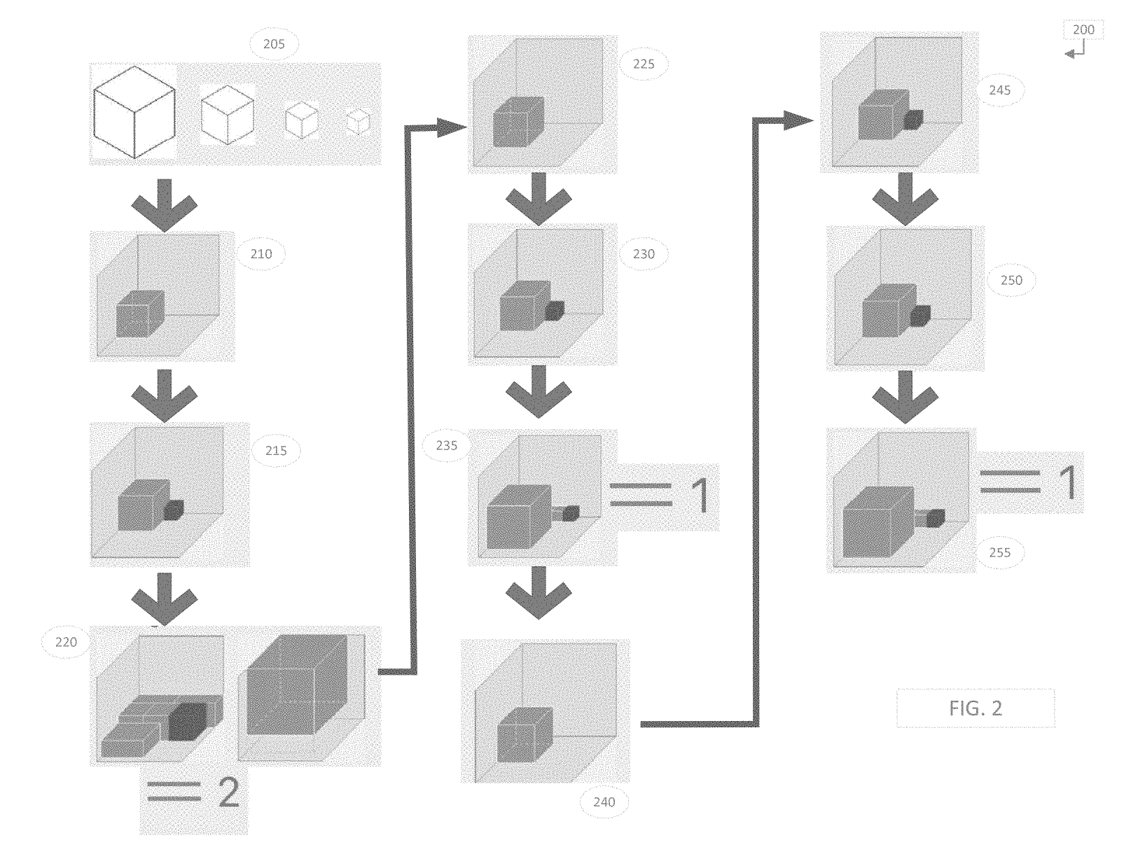

At the completion of act 102, representative process 100 proceeds to act 104, wherein the shipping container(s) for the shipment are identified, and a manner of packing the selected items within the shipping container(s) is determined. This may be performed in any of numerous ways. One representative manner of doing so is shown in FIG. 2.

Those skilled in the computer programming arts will recognize that the “bin-packing problem,” wherein one or more receptacles are chosen to hold a collection of items, and/or the items are virtually arranged in the receptacle(s) to achieve various goals (e.g., to minimize the amount of volume occupied by packed items), is a well-known one in computer science, and that many different approaches to the problem have been attempted (see, e.g., Determining the Optimum Ordering Policy in Multi-Item Joint Replenishment Problem Using a Novel Method, Hindawi Publishing Corporation, Mathematical Problems in Engineering, Vol. 2013, Art. 469794, which is incorporated herein by reference in its entirety). In one conventional approach, all possible arrangements of a collection of items in a receptacle are virtually attempted before a single “optimal” arrangement is identified which achieves one or more specified goals (e.g., minimal volume consumption). Another, more straightforward approach involves first virtually “placing” the largest of the collection of items in a corner of the receptacle, and then placing the next largest of the items into a space in which the item will fit, and then the next largest into a space into which it will fit, and so on until all items have been placed in the receptacle.

The Assignee has appreciated that while the approach outlined above which involves attempting all possible arrangements of items in a shipment usually results in the most space savings, it is also computationally expensive and time-consuming. The Assignee has also recognized that while the other, more straightforward approach outlined above typically consumes less computational resources and time, it also often results in space within shipping containers being wasted. As such, the process depicted in FIG. 2 seeks to balance these competing concerns by achieving significant space savings without consuming excessive time and computational resources. Specifically, this process involves (1) placing a collection of items in a virtual shipment in an order defined by each item's size, so that the largest item in the collection is placed in the virtual shipment first, and then the next largest item, and so on until all of the items have been placed; and (2) attempting all possible orientations of each item so as to yield a shipment which occupies the minimum number of shipping containers, and the minimum volume within the shipping container(s).

Representative process 200 (FIG. 2) begins at 205, wherein the set of items selected by the consumer is sorted from largest to smallest. Of course, although the items are represented by cubes in FIG. 2, items which are selected by a consumer may take any of numerous shapes and forms, and so sorting the items from largest to smallest may, for example, include comparing the total volume of each item (e.g., as modified by packing materials utilized for seasonality and/or to protect certain items in a shipment from other items). However, it should be appreciated that items need not be sorted according to total volume, and that any suitable physical characteristic(s) may be used. For example, items could be sorted according to length of longest side, etc.

The process then proceeds to 210, wherein the first (i.e., largest) item is virtually placed in one or more initially selected shipping containers. The initial selection of one or more shipping containers may be accomplished in any of numerous ways. For example, a collection of shipping containers of predetermined sizes may be used for all shipments, and one or more containers may be initially selected from among the collection based upon one or more physical characteristics of the items and the container(s). For example, one or more containers may be initially selected based upon a comparison between the total volume of the items to be packed and the volume which each of the collection of containers will accommodate, and/or the total weight of the items and any weight limits which are applicable to particular containers.

At 210, the first item is placed in an initial orientation, which may be determined in any suitable way, including arbitrarily. The item is then virtually placed so that one of its corners resides in a corner of the selected shipping container. That is, if the dimensions of the shipping container were defined using a 3-dimensional Cartesian coordinate system, then the corner of the item would be placed at (0, 0, 0) within the shipping container.

In act 215, the second (i.e., next largest) item is virtually placed in the shipping container in an initial orientation and at a location adjacent the first item and the back wall of the container. Although the second item is able to fit in this location in the example shown in FIG. 2, in some instances, the second item may not fit. If there is not enough room in the shipping container to accommodate the second item in this location, then another shipping container may be selected, and the items may be distributed across the two shipping containers.

This process continues until all items selected by the consumer have been placed in one or more shipping containers in an initial orientation, as shown at 220. The number of shipping containers used for the shipment is identified, and stored as a current lowest number of containers for the shipment.

At 225, the step which is described above at 210 is repeated, except that the first item is rotated to a second orientation so that it sits on a different side than in the initial orientation. In the example shown in which each cube representing an item has six sides, there are six possible orientations for each item. Of course, other items having other shapes may have more or less sides on which to sit, and/or restrictions as to possible orientations, and thus more or less possible orientations.

At 230 and 235, the steps which are described above at 215 and 220 are repeated. Specifically, the second, upright item is placed in its initial orientation so that it contacts the first, rotated item and the back wall of the shipping container. This is repeated until all remaining items are packed. If less shipping containers are used with the first item in this orientation than the current lowest number of containers for the shipment, then the number of containers used is stored as the current lowest number of containers for the shipment. The total remaining volume in each shipping container is also determined.

At 240 the step which is described above at 210 is repeated again, with the first item being rotated again to a third orientation. The steps which are described above at 215-220 are then repeated again. If less shipping containers are used with the first item in this orientation than the current lowest number of containers for the shipment, then the number of containers used is stored as the current lowest number of containers for the shipment. The total remaining volume in each shipping container is also determined. This procedure is then repeated for all possible orientations of the first item.

At 245 the first item is placed in the shipping container in the position which yielded the current lowest number of containers needed for the shipment above. The second item is then rotated to a different orientation than the one in which it sat in the act 215, and placed adjacent the first item and against the back wall. The remaining items are then placed in their initial orientation in the container. If less shipping containers are used with the second item in this orientation than the current lowest number of containers for the shipment, then the number of containers used is stored as the current lowest number of containers for the shipment. The total remaining volume in each shipping container is also determined. This procedure is then repeated for all possible orientations of the second item.

At 250 the step which is described above at 245 is repeated, except that the first and second items are placed in the shipping container in the positions which yielded the current lowest number of containers for the shipment, and the third item is rotated to a different orientation, and placed adjacent the second item. The remaining items are then placed in the container in their initial orientations. If less shipping containers are used with the third item in this orientation than the current lowest number of containers for the shipment, then the number of containers used is stored as the current lowest number of containers for the shipment. The total remaining volume in each shipping container is also determined. This procedure is then repeated for all possible orientations of the third item.

The procedure described above at 250 is then repeated for all remaining items. If a particular arrangement uses a lower number of shipping containers than the current lowest number of containers for the shipment, then the number of containers used is stored as the current lowest number of containers for the shipment, as depicted at 255. The total remaining volume in each shipping container is also determined for each arrangement.

An arrangement is then chosen based upon the total number of shipping containers used and the volume remaining within each container. Specifically, in the example shown, the total number of shipping containers used is prioritized above remaining volume in choosing an arrangement for the shipment, given the Assignee's recognition that the number of shipping containers used in a shipment has the greatest effect on the environmental and monetary cost of the shipment. As such, an arrangement is chosen which, among all the potential arrangements that use the smallest number of containers, yields the most remaining volume. Representative process 200 then completes. The result of representative process 200 is a “virtual shipment” defining how the items selected by the consumer are to be arranged in each shipping container.

It should be appreciated that any of numerous variations on the process shown in FIG. 2 may be used without departing from the spirit and scope of the invention. As one example, an arrangement may be selected for a shipment using a different set of priorities than those which are described above, such as in a way which prioritizes remaining volume over the total number of shipping containers used. As another example, each potential arrangement of items in a shipment may, additionally or alternatively, be evaluated based upon physical characteristics other than the size of the various items included in the shipment. For example, each potential arrangement may be evaluated based at least in part upon the weight of one or more items (e.g., whether a particular arrangement causes a weight limit for any individual shipping container to be exceeded), the fragility of one or more items (e.g., so that an arrangement does not include a particularly fragile item packed with less fragile items, such as an item in a glass container being packed with items in metal containers, a bag of potato chips being packed with cans of soda, etc.), and/or other suitable physical characteristic(s). In some embodiments, each potential arrangement may be evaluated based at least in part upon user-specified preferences, such as whether a potential arrangement exceeds a consumer-specified weight, size, etc. In some embodiments, a potential arrangement may be evaluated based at least in part upon characteristics of the packaging material and/or dunnage to be used, such as the quantity, weight, and/or cost of the packaging material and/or dunnage. A potential arrangement may be evaluated based upon any suitable consideration(s), in any suitable way, as the invention is not limited in this respect.

Referring again to FIG. 1, at the completion of act 104, representative process 100 proceeds to a series of acts (i.e., acts 120-130) in which any “add-on” items that will fit within the remaining volume in the identified shipping container(s) and will not cause any shipping container to exceed any applicable weight limits are identified. The item(s) are then offered to the consumer and, if one is selected, the item is placed so as to yield the maximum remaining volume. After any “add-on” item is selected, the volume that remains (i.e., after the item is placed) is determined, and any additional items which will fit within the remaining volume and will not cause the shipment to exceed any applicable weight limits (and/or any other suitable criteria) are identified. The process repeats in this manner until either the consumer opts to not include any additional items in the shipment, or no more items will fit. Acts 120-130 are described in further detail below.

In act 120, the remaining volume in the shipment is determined. Initially, before any “add-on” items are selected for inclusion, the remaining volume may have been determined in act 104 as part of the process of creating the virtual shipment. After an add-on item is selected for inclusion, determining the remaining volume may involve considering how placing the add-on item in the shipment affects the remaining volume.

In act 122, a determination is made whether any add-on items are available which will fit into the remaining volume and will not cause any weight limits to be exceeded. Add-on items may be identified in any suitable manner. For example, a collection of items that are known to occupy relatively little volume and have relatively low weight may be predefined, and act 122 may involve choosing from this collection. Of course, the invention is not limited to such an implementation, as add-on items may be identified in any suitable fashion. For example, in some embodiments, add-on items may be identified in act 122 based upon the demonstrated preferences of the consumer. For example, information on items which the consumer has previously selected for purchase, previously viewed for at least a certain amount of time, “clicked on” during previous visits, and/or any other suitable information (whether or not related to particular items) may be used to identify add-on item(s) in act 122.

As another example, in some embodiments, the identification of certain add-on items in act 122 may be based at least in part upon the seller(s) of such items having provided consideration (e.g., payment) in exchange for being identified.

As another example, add-on items may be identified in act 122 based upon the demonstrated preferences of a population of consumers (which may or may not include the consumer for which add-on items are being selected). For example, one or more machine learning techniques may be used to identify and/or predict which add-on item(s) that may appeal to a particular consumer based upon the preferences demonstrated by a population of consumers over time.

If it is determined in act 122 that there are no add-on items available which will fit within the remaining volume in the virtual shipment and not cause any weight limits to be exceeded, then representative process 100 completes. For example, if representative process 100 is performed as part of a “checkout” process provided by an e-commerce site, then the completion of representative process 100 may mean that the consumer is taken to a payment procedure to conclude the checkout process.

However, if it is determined in act 122 that there are add-on items which will fit in the remaining volume and not cause any weight limits to be exceeded, then representative process 100 proceeds to act 124, wherein the identified add-on item(s) is (are) offered to the consumer for inclusion in the shipment. For example, a representation of each add-on item may be displayed to the consumer via a graphical user interface, so that the user may select a particular add-on item for inclusion.

In some embodiments, a consumer may be offered an incentive to include an add-on item in a shipment, to encourage the consumer to use the packaging material constituting the shipping container(s) as fully as possible. For example, in some embodiments, add-on items may be offered at a discount. The amount of the discount may be determined in any suitable fashion. For example, all add-on items may be discounted by the same (e.g., predefined) percentage. As another example, different items may be discounted to different extents (including offering certain items free of charge), to achieve any of numerous objectives. For example, a larger discount may be applied to an add-on item for which a retailer has excess inventory, to a more expensive item, to an item which the consumer is determined to be less likely to select (e.g., as determined through an analysis of his/her demonstrated preferences, and/or through an analysis of the preferences of one or more other consumers), to an item which is determined to occupy at least a threshold percentage of the remaining volume in the shipment (so as to ensure that packaging material is fully utilized), and/or to items which satisfy any of numerous other criteria.

Representative process 100 then proceeds to act 126, wherein the selection of an add-on item is received from the consumer. For example, a consumer may indicate selection of an add-on item via mouse, keyboard, speech and/or any other suitable form of input.

Then, in act 128, the selected add-on item is incorporated into the virtual shipment, and placed so as to yield the maximum remaining volume in the shipping container(s) for the shipment. This may be performed in any of numerous ways. For example, techniques like those which are described above with reference to FIG. 2 may be used to determine a placement of the add-on item so as to yield maximum remaining volume in the shipping container(s).

Representative process 100 then proceeds to act 130, wherein a determination is made whether any of the add-on items identified in act 122 remain available for potential inclusion in the shipment. If so, then the process returns to act 120, wherein the remaining volume is determined, and proceeds as described above. Acts 120-130 are then repeated until there are no more add-on items available for inclusion in the virtual shipment, or the consumer opts to not include any more items. Representative process 100 then completes.

It should be appreciated that, as with the process described above with reference to FIG. 2, numerous variations on representative process 100 may be used without departing from the spirit and scope of the invention. For example, some variations may include additional acts which are not described above, may not include all of the acts described above, or may include some or all of the acts being performed in a different sequence than is described above.

As an example, some variations may allow a consumer to specify his/her order in its entirety without being shown options for add-on items until after the order is finalized. The consumer may, for example, then be allowed to “reopen” his/her virtual shopping cart, and to select one or more add-on items which are presented to him/her for inclusion in the order (e.g., using acts 120-130 described above).

As another example, some variations may allow a consumer to exit the process described above prior to its completion. For example, if a consumer realizes after initially selecting a set of items for purchase that he/she intended to buy another item as well, then the consumer may exit the process to add the other item to his/her shopping cart. If this occurs, in some embodiments, any “add-on” items which the consumer had selected for inclusion in the shipment prior to exiting may be removed, since the add-on item(s) were chosen based upon on an amount of remaining volume and the total weight of the items previously selected, and this amount of volume may change after the other item is added and any other changes to the items in the shopping cart are made. For this reason as well, when the consumer re-enters the check-out process, a new set of “add-on” items may be identified for inclusion, based upon the total item weight and/or remaining volume after the other items is selected. Further, if any identified “add-on” item is the same as an “add-on” item which was previously offered to the consumer (e.g., before he/she exited the checkout process), the consumer may be offered a different incentive to select the add-on item, depending (for example) on the weight and/or volume remaining in the shipment, and/or other factors.

As yet another example, some variations may provide for one or more add-on items to be included in an order without the consumer affirmatively selecting the item(s), such as to ensure that the packaging material constituting any shipping container(s) is utilized as fully as possible. In such variations, one or more add-on items may be automatically included in a consumer's order based upon an analysis of the preferences of the consumer (and/or a group of consumers). The consumer may or may not be charged for the add-on item(s) automatically included in the order, and may be allowed to return the add-on item(s) if he/she is not satisfied with the add-on item(s).

It should be appreciated that the invention is not limited to enabling a consumer to minimize the environmental cost of a shipment by specifying the extent to which the packaging material constituting one or more shipping containers is used. A consumer may tailor a shipment to achieve any of numerous objectives. For example, a consumer may tailor a shipment to ensure that no one shipping container in the shipment exceeds a predefined weight, exceeds a predefined size (which may be defined based upon volume, the length of a side, or in any other suitable fashion), and/or has any of numerous other characteristics.

A representative process 300 for enabling a consumer to tailor a shipment to achieve one or more objectives is shown in FIG. 3. Unlike the representative process 100 which is shown in FIG. 1 (wherein the manner of arranging items in a shipment is defined only after all items are selected), representative process 300 is performed as the consumer selects each item for inclusion in the shipment, so that he/she may visually appreciate (e.g., via information presented by a graphical user interface) how the placement and physical characteristics of each item affects the shipment overall.

Representative process 300 starts in act 302, wherein input is received from a consumer defining one or more objectives for the shipment. This input may take any suitable form, and may specify any suitable objective(s) for a shipment.

In act 304, the selection of an item for purchase is received from the consumer, and a particular shipping container is identified for the selected item in act 306. A shipping container may be identified in any suitable fashion. In some embodiments, the physical dimensions and weight of all of the items that a consumer may select may be known a priori, and the shipping container may be selected based upon the physical characteristics of the selected item, such as to accommodate its volume and weight.

In act 308, the placement of the selected item in the selected shipping container, the remaining volume in the shipping container after the item is placed within, and the total weight of the shipment are determined, and this information is displayed to the consumer. The manner in which the item is placed within the shipping container may, for example, be defined using aspects of the process described above with reference to FIG. 2, and/or any other suitable technique(s). In some embodiments, a selected item may be placed in the selected shipping container in an initial location and position. If and when an additional item is selected (as described further below), the location and/or position of an already-packed item may be revised to accommodate the additional item, such as to maximize the remaining volume in the shipment, and/or in response to user input. If the inclusion of an additional item causes a weight limit for the shipment to be exceeded, then any already-packed items and the additional item may be distributed across multiple shipping containers.

Information may be displayed to the consumer in act 308 in any suitable way. For example, some embodiments may provide for a visual rendering of the shipping container and/or the contents thereof to be displayed to the consumer via a graphical user interface so that the consumer may be given a visual sense for the remaining volume in the container, the total weight of items in the container, and/or other shipment or item characteristics.

Representative process 300 then proceeds to act 310, wherein a determination is made whether any input from the consumer indicates that he/she wishes to add more items to the shipment. If not, then representative process 300 completes, and if so, then representative process 300 returns to act 304, wherein a selection of one or more additional items is received from the consumer. Acts 306-310 are then repeated as described above until the consumer determines that his/her order is complete.

It should be appreciated that, as with the processes described above with reference to FIGS. 1 and 2, numerous variations on representative process 300 may be used without departing from the spirit and scope of the invention. For example, some variations may include additional acts which are not described above, may not include all of the acts described above, or may include some or all of the acts being performed in a different sequence than is described above. As one example, some variations may provide for one or more add-on items to be included in an order without the consumer affirmatively selecting the item(s), such as to ensure that the packaging material constituting any shipping container(s) used for the order is utilized as fully as possible. In such variations, one or more add-on items may be automatically included in a consumer's order based upon an analysis of the preferences of the consumer (or a group of consumers). As with the variation on representative process 100 described above, the consumer may or may not be charged for the add-on item(s), and may be allowed to return the add-on item(s) if he/she is not satisfied with the add-on item(s).

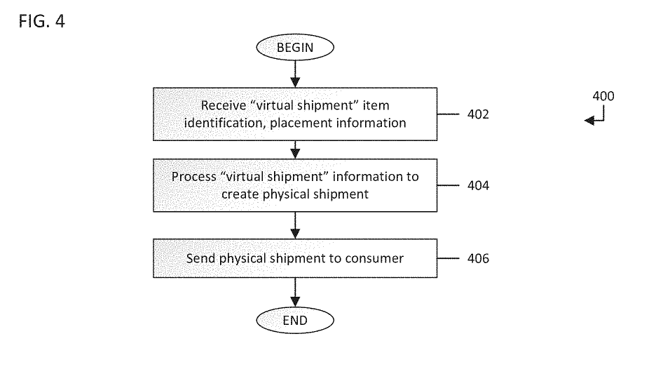

FIG. 4 depicts a representative process 400 for creating a physical shipment for delivery to a consumer based upon a virtual shipment. Representative process 400 begins in act 402, wherein the virtual shipment, comprising an identification of the items which are to be included in the shipment, and the manner in which each item is to be arranged in a shipping container, is received. The virtual shipment may be created, for example, as a result of performing representative process 100 (FIG. 1) or representative process 300 (FIG. 3).

The process then proceeds to act 404, wherein the virtual shipment is processed to create a physical shipment. Information comprising the virtual shipment may be processed in any of numerous ways to produce a physical shipment. For example, a person may visually inspect the information and pick and pack the specified items into one or more shipping containers, in the manner specified. As another example, one or more automated components may process the information to select specified items from inventory, pack the items in one or more shipping containers in the manner specified, and seal the container(s). Any suitable technique(s) may be used, including manual, automated or a combination of manual and automated techniques.

Representative process 400 then proceeds to act 406, wherein the shipment is sent to the consumer. This, too, may be performed in any suitable fashion, such as by engaging a delivery company for this purpose. Representative process 400 then completes.

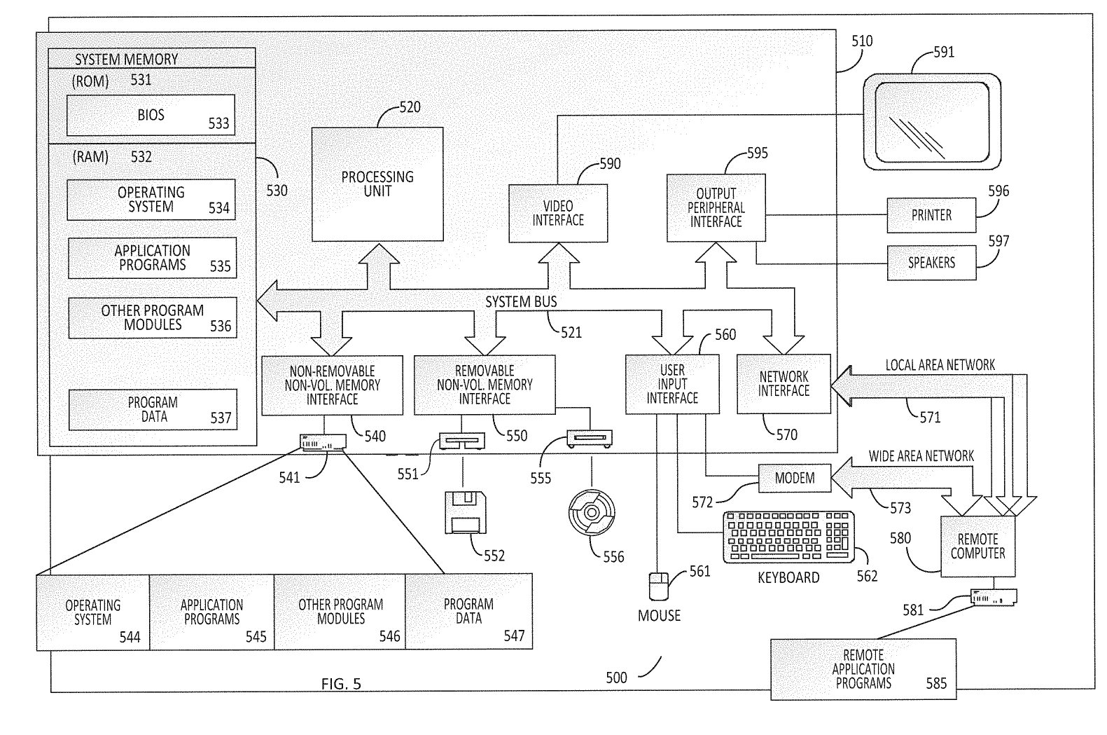

It should be appreciated from the foregoing that some aspects of the invention may be implemented using a computing device. For example, any or all of the representative processes described above with reference to FIGS. 1-4 may be performed, wholly or in part, using a computing device. FIG. 5 depicts a general purpose computing device, in the form of a computer 510, which may be used to implement certain aspects of the invention. For example, computer 510 or components thereof may constitute any of the audio controllers, mobile devices, and/or networking components described above.

In computer 510, components include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 510. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 539, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 559 such as a CD ROM or other optical media. Other removable/non-removable, volatile/nonvolatile computer storage media that can be used in the exemplary computing system include, but are not limited to, magnetic tape cassettes, flash memory cards, digital versatile disks, digital video tape, solid state RAM, solid state ROM, and the like. The hard disk drive 541 is typically connected to the system bus 521 through an non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 549, and program data 547. Note that these components can either be the same as or different from operating system 534, application programs 535, other program modules 539, and program data 537. Operating system 544, application programs 545, other program modules 549, and program data 547 are given different numbers here to illustrate that, at a minimum, they are different copies. A user may enter commands and information into the computer 510 through input devices such as a keyboard 592 and pointing device 591, commonly referred to as a mouse, trackball or touch pad. Other input devices (not shown) may include a microphone, joystick, game pad, satellite dish, scanner, or the like. These and other input devices are often connected to the processing unit 520 through a user input interface 590 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 599, which may be connected through a output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 590, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Embodiments of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a computer readable medium other than a computer-readable storage medium. Examples of computer readable media which are not computer readable storage media include transitory media, like propagating signals.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The invention may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those which are described, and/or which may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for reducing the environmental impact of a shipment of items, the method comprising acts of:
(A) receiving information identifying multiple items selected for a consumer;
(B) generating a virtual shipment for the multiple items, the virtual shipment defining at least one shipping container for the shipment, a placement of each of the multiple items within the at least one shipping container, and a remaining volume within the at least one shipping container after the multiple items are placed within the at least one shipping container;
(C) based at least in part upon the remaining volume within the at least one shipping container, identifying one or more additional items for potential inclusion in the shipment by comparing a volume for each of the one or more additional items to the remaining volume;
(D) identifying at least one additional item to occupy at least a portion of the remaining volume in the shipment; and
(E) preparing a physical shipment to send to the consumer based upon the virtual shipment generated in the act (B) and the identification of the at least one additional item in the act (D).

2. The method of claim 1, wherein the act (A) comprises receiving input from the consumer defining a selection of the multiple items for purchase.

3. The method of claim 1, wherein each of the multiple items for which identifying information is received in the act (A) has an associated physical characteristic, and wherein the act (B) comprises generating a virtual shipment in a manner which satisfies a condition relating to the physical characteristic.

4. The method of claim 1, wherein the act (B) comprises executing programmed instructions defining a bin-packing algorithm.

5. The method of claim 4, wherein the bin-packing algorithm provides for:
virtually placing the multiple items in the at least one shipping container in an order defined by item size, from a largest of the multiple items to a smallest of the multiple items; and
virtually placing each of the multiple items in the at least one shipping container in an orientation which yields a maximum remaining volume in the at least one shipping container.

6. The method of claim 1, wherein the act (B) comprises generating the virtual shipment so as to include a maximum remaining volume within the at least one shipping container after the multiple items are placed within.

7. The method of claim 1, wherein the act (C) comprises selecting the one or more additional items from a predefined collection of items.

8. The method of claim 1, wherein the act (C) comprises identifying the one or more additional items based at least in part upon the remaining volume in the virtual shipment.

9. The method of claim 1, wherein the act (C) comprises identifying the one or more additional items based at least in part upon a preference previously exhibited by the consumer.

10. The method of claim 1, wherein the act (C) comprises identifying the one or more additional items based at least in part upon preferences previously exhibited by one or more consumers other than the consumer from which the selection is received in the act (A).

11. The method of claim 1, wherein the act (D) comprises receiving input, from the consumer, defining a selection of the at least one additional item for the shipment.

12. The method of claim 1, wherein the act (D) comprises receiving, from the consumer, input defining a selection of a first additional item for the shipment; and
executing programmed instructions defining a bin-packing algorithm to determine a placement of the first additional item within the at least one shipping container so as to yield a maximum remaining volume in the at least one shipping container after the first additional item is placed in the at least one shipping container.

13. The method of claim 1, wherein the act (D) comprises revising the virtual shipment generated in the act (B) so as to include a maximum remaining volume in the at least one shipping container after the at least one additional item is placed in the at least one shipping container.

14. A method for reducing the environmental impact of a shipment of items, the method comprising acts of:
(A) receiving, from a consumer, input defining a selection of a first item to be included in the shipment and at least one objective for the shipment;
(B) generating a virtual shipment to include the first item based at least in part upon the input received in the act (A), the virtual shipment defining at least one shipping container for the shipment, a placement of the first item within the at least one shipping container, and an indication of a volume remaining within the at least one shipping container after the first item is placed within the at least one shipping container;
(C) causing to be displayed, to the consumer, a visual representation of the virtual shipment and information relating to the at least one objective for the shipment;
(D) receiving, from the consumer, input defining a selection of a second item to be included in the shipment;
(E) revising the virtual shipment generated in the act (B), the revised virtual shipment defining a placement of the first and second items within the at least one shipping container and a remaining volume within the at least one shipping container after the first and second items are placed within the at least one shipping container;
(F) causing to be displayed, to the consumer, a visual representation of the revised virtual shipment and information relating to the at least one objective for the shipment;
(G) receiving input from the consumer defining at least one modification to the revised virtual shipment;
(H) preparing a physical shipment to send to the consumer, based at least in part upon the revised virtual shipment and the input defining the at least one modification received in the act (G).

15. The method of claim 14, wherein the at least one objective for the shipment relates to at least one of reducing packaging waste for the shipment and reducing a total weight of the shipment.

16. The method of claim 14, wherein at least one of the acts (B) and (E) comprises executing programmed instructions defining a bin-packing algorithm.

17. The method of claim 14, wherein the act (E) comprises defining a placement of the first and second items within the at least one shipping container so as to yield a maximum remaining volume within the at least one shipping container after the first and second items are placed within the at least one shipping container.

18. The method of claim 14, wherein the act (G) comprises receiving input from the consumer resulting in a reduction of an overall weight for the shipment or a decrease in remaining volume within the at least one shipping container.

19. The method of claim 18, wherein the act (G) comprises receiving input resulting in a decrease in remaining volume within the at least one shipping container, and wherein the input relates to selecting an additional item to be included in the shipment.
